(19) United States
(12) Patent Application Publication
(10) Pub. No.: US 2009/0088039 A1
(43) Pub. Date: Apr. 2, 2009

(54) Process for Producing a Sound-Insulation Part

(76) Inventor: Thomas Freser-Wolzenburg, Garbsen (DE)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/280,128

(22) PCT Filed: Feb. 16, 2007
(86) PCT No.: PCT/EP2007/001375

§ 371 Date: Nov. 21, 2008

(30) Foreign Application Priority Data
Feb. 20, 2006 (DE) 10 2006 007 784.9

(51) Int. Cl. B32B 5/16; B29C 51/02; C04B 35/64; B32B 3/26; B32B 27/40

(52) U.S. Cl. 442/417; 264/292; 264/603; 428/423.1; 428/304.4

(57) ABSTRACT

A method for producing a noise insulation piece of mass/spring construction. The mass has, at least before a deep draw process, at least one locally defined region, with a different weight per area from the other regions. After the deep draw process, the spring layer made from an elastic light material such as two-component polyurethane foam or a mixed non-woven fiber is applied. The locally different weight per area of the mass is achieved by means of application of a granulate to a base mass layer in particular in locally differing amounts and/or thicknesses, wherein the granulate is fixed to itself and to the base mass layer by means of sintering. After deep drawing, the desired weight per area of the mass can be achieved independent of the degree of drawing. The granulate can alternatively also be applied to a thin and lightweight support layer in locally required amounts or thicknesses.

The invention relates to a process for producing a sound-insulation part having a mass/spring structure, wherein a spring layer comprising an elastic lightweight material, such as a two-component polyurethane foam or a mixed-fiber non-woven fabric, and a mass layer, with or without laminated-on carpet, are formed, whereby for the purpose of adaptation to the contour of a surface to be dampened the mass layer is subjected to a corresponding thermoforming process and subsequently the spring layer is applied, as well as to such a sound-insulation part.

Sound-insulation parts of the stated type are used, in particular, in the motor-vehicle industry for covering the floor region of a motor vehicle in the region of the transmission tunnel, and/or for covering the region pointing towards the engine and/or the flat regions in the footwell of the motor vehicle. Therefore the mass production of such sound-insulation parts, and the problems arising thereby, on the one hand, and the saving of unnecessary materials or, to be more precise, the reduction in weight, on the other hand, are important.

Known as such from the state of the art are molded sound insulations with integrated carpet in a design in the form of a mass/spring system, in which a foam backing comprising polyurethane foam is provided for the spring layer. A multilayer sound-deadening structural part for a vehicle body composed of pressed panels is known from DE-AS-2006741. This sound-deadening structural part comprises a layer of dynamically soft material, such as, for example, foamed material or even a mixed-fiber non-woven fabric, which is supported on the body in floating manner, and a heavy layer, which is arranged on the soft material, and also of a carpet or some other covering which has been applied on the heavy layer. This layered arrangement improves the sound-deadening and also reduces the transmission of the structure-borne sound from the body into the passenger compartment of the vehicle.

A molded foam-backed carpet structure that is capable of being used in motor vehicles is known from U.S. Pat. No. 4,579,764. The structure comprises a carpet layer, with an applied mouldable thermoplastic polymer layer, and an acoustically deadening foam layer which is connected to the thermoplastic polymer layer. By way of flexible foam-deadening material, use is made, for example, of a polyurethane foam having a predominantly open-cell structure, or even of mixed-fiber non-woven fabrics, which are brought into the appropriate shape with the aid of folding processes or pressing processes. In order to reduce the weight of such a sound-insulation part and in order to obtain a better adaptation to the structure to be deadened, the polyurethane foam or the non-woven fabric (or comparable materials) is preferably provided only at a few selected regions beneath the thermoplastic polymer layer.

The physical laws to which sound-insulation parts based on a mass/spring system conform are elucidated in detail in the literature, for example in the company publication entitled “Information NL 130” (“Fortschrittliche Schallisolation für Automobile”) [Information NL 130, Advanced sound insulation for automobiles], produced by Stankiewicz GmbH, published for the 52nd International Motor Show, Frankfurt, Main, 11th to 20 Sep. 1987.

In the case of sound-insulation parts according to this known state of the art, importance was hitherto attached to the fact that, within the frequency range below 300 Hz, falls in the deadening of sound in comparison with the deadening of a naked bodywork panel are avoided by means of the mass/spring systems. This frequency range below 300 Hz is frequently excited to produce droning, particularly in the case of four-cylinder-engine vehicles by virtue of the speed-dependent ignition frequency.

Four-cylinder-engine vehicles of the latest generation, and also vehicles with multi-cylinder engines—such as six-cylinder engines—are no longer subject to the droning noises, or the latter occur only to a greatly reduced extent. Instead, high-frequency noises within the frequency range starting from 300 Hz appear increasingly in disturbing manner.

As a rule, the acoustic base load does not arise uniformly over the entire region to be considered—for example, the floor region—but rather there are regions of higher base load and regions of lower base load. FIG. 3 shows, on the basis of an exemplary sound-insulation part for the floor region of a vehicle, dark regions, which correspond to regions of higher base load, such as in the region of a transmission tunnel or in the region situated towards the engine, and also light regions corresponding to low base load, such as for the flat regions in the footwell.

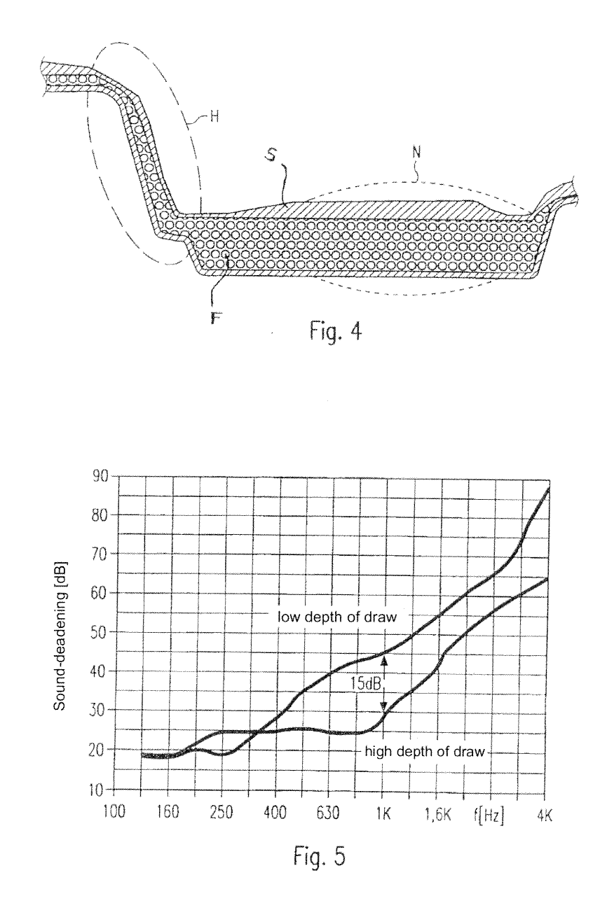

Sound-insulation parts of such a type, of which the floor lining shown in FIG. 3 is a typical example, are produced, in accordance with the state of the art, using the thermoforming process. In particular, the mass layer, with or without laminated-on carpet, which constitutes the visible side when the sound-insulation part is manufactured, is deformed in the thermoforming process. Starting from a planar semi-finished product (‘blank’) of uniform thickness for the mass layer, after the thermoforming in the case of the exemplary embodiment of a floor lining there arise regions having a low depth of draw, in which 70% to 90% of the original weight per unit area is preserved, and regions having a high depth of draw, in which merely 50% to 60% of the original weight per unit area is preserved, as represented in FIG. 4. FIG. 4 shows, in section, an exemplary region with a mass layer which has been foam-backed after the thermoforming procedure in a mould. It becomes evident that the heavy layer or mass layer S have variable acoustic effectiveness after the thermoforming, despite the use of variably thick spring layers F. As is apparent from FIG. 5, within an exemplary floor lining by way of sound-insulation part which has been thermoformed from a semi-finished product or blank of constantly uniform weight per unit area, differences in sound-deadening of up to 15 dB may result, depending on the depth of draw. On the other hand, however, the regions that are greatly thinned out in the course of thermoforming (high depth of draw) and that are consequently highly limited in their acoustic effectiveness are frequently congruent with the regions of the part of a body to be acoustically deadened that have a particularly high acoustic excitation, such as, for example, the transmission tunnel in the case of the body of a vehicle.

This represents a conflict of aims.

Several approaches have been pursued hitherto with a view to resolving this conflict of aims. One procedure according to the state of the art is to increase the initial weight per unit area of the thermoplastic semi-finished product (blank) so much that sufficient weight per unit area is present in the acoustically critical regions also after the thermoforming, and the desired deadening can be achieved. However, this has the disadvantage that clearly too much mass is present in the regions having lower depths of draw and having lower acoustic excitation. However, the material of the mass is cost-intensive and increases the weight of the vehicle unnecessarily. Hence the fuel consumption is also increased.

Another known procedure is the use of inserts comprising the same material as the thermoplastic heavy layer, which prior to the thermoforming operation are applied onto the relevant regions of the semi-finished product or blank and locally increase the weight per unit area there. This has the fundamental disadvantage that the initial weight per unit area prior to the thermoforming can be differentiated only in very coarse steps. Moreover, substantial costs arise for the separate manufacture of such inserts, as well as the handling thereof in the course of insertion. These costs increase linearly with the degree of local differentiation.

Lastly, another procedure is known from DE 101 61 600 A1, wherein a filled polyurethane is sprayed on locally in selective manner, as a result of which additional local masses arise selectively on the already deformed (thermoformed) mass layer of the sound-insulation part. A very good differentiation is advantageous. Disadvantageous, however, are the extremely high material costs of the polyurethane (for the mass layer) in comparison with a filled thermoplastic, as well as the high expenditure in terms of apparatus. The process-time, the time for producing a sound-insulation part in the case of mass production, also depends greatly on the quantity of the additional mass that can be discharged per unit time, and on the necessary mass on the sound-insulation part.

Proceeding from here, the object of the present invention is to specify a process for producing a sound-insulation part that can be performed at favorable cost and that permits the mass of the mass layer in the acoustically critical regions to be increased with the desired degree of differentiation.

It is also an object of the invention to specify a corresponding sound-insulation part.

The object is achieved, in the case of a process, by means of the features of Claim 1 or of Claim 3. The object is achieved, in the case of a sound-insulation part, by means of the features of Claim 10 or of Claim 12.

The invention is developed further by the features of the dependent claims.

The locally, locally or partially increased weight per unit mass of the mass layer is generated, in accordance with the invention, by a granular material comprising thermoplastic material being applied in solid form, prior to the thermoforming, onto the side of the mass layer facing away from the carpet or from the visible side. Use is expediently made of a granular material that comprises the same thermoplastic material—or of a thermoplastic material that is similar in terms of melting-point and density—as that of the mass layer.

The granular material advantageously has a grain size from 0.5 mm to 6 mm, preferably 2 mm to 4 mm, by virtue of which the desired layer thickness or layer height, and hence the desired additional mass, can be adjusted very precisely. Application of the granular material is expediently undertaken with the aid of a die, a guide bar, an engaged template or another process that is able to obtain the desired accuracy in the course of local application of the granular material.

The adjustment of the acoustically desired local weight per unit area of the mass layer as a whole is undertaken via the definition (adjustment) of the height of the granular material to be applied or by means of the quantity of granular material applied per unit area.

The applied granular material is subsequently heated up together with the remaining structure, for example in one or more heating bays. Subsequently the solidification of the granular material on the mass layer follows during the thermoforming, in the course of which the granular material is sintered together under pressure and temperature, and in this way forms a homogeneous layer which is firmly connected to the mass layer (or to the backing layer). For the acoustic effect it is surprisingly advantageous that the additional mass sintered from the granular material is clearly more flexible, by reason of the process sequence, than a base mass layer that has been manufactured from identical material and that has been thermoformed from a semi-finished product exhibiting, as explained, continuously identical thickness, such as a blank.

It becomes evident that, prior to the thermoforming, the base mass layer has to exhibit only the thickness that the lowest locally desired mass per unit area has to have after the thermoforming. Consequently, very lightweight sound-insulation parts are achievable.

It becomes evident that even somewhat lighter sound insulations can be produced if, instead of a base mass layer, use is made of a thin and lightweight backing layer that has the necessary rigidity (for a thermoforming process). It may be a question of a compressed or needled mixed-fiber non-woven fabric or a comparable material. Onto this backing layer the granular material can then be applied and sintered in the described way in the locally required quantity in each case, it also being possible for extremely thin mass layers to be achieved locally in this way. This procedure is a particular advantage when, for acoustic reasons, a mass layer can even be dispensed with in surface regions.

The invention will be elucidated on the basis of the exemplary embodiments represented schematically in the drawing. Shown are:

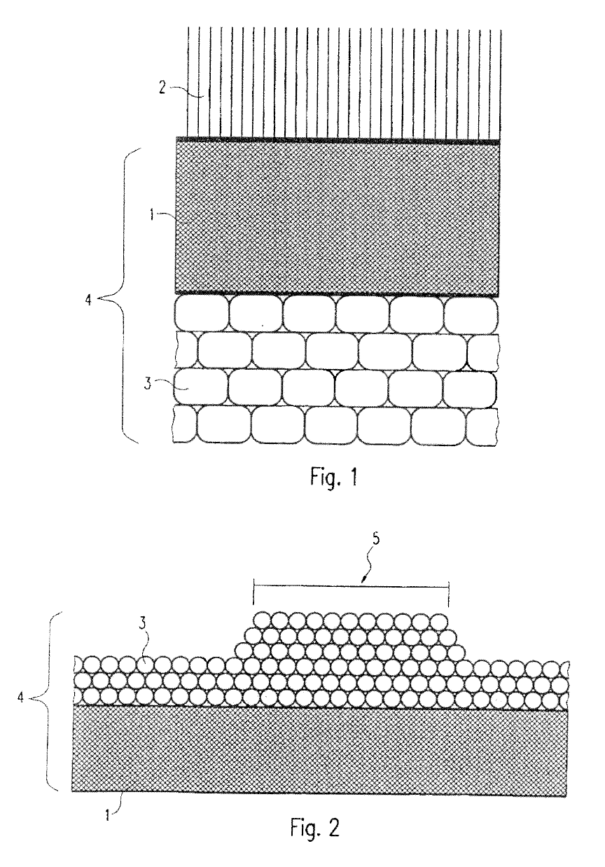

FIG. 1 in section, a mass-layer arrangement according to the invention,

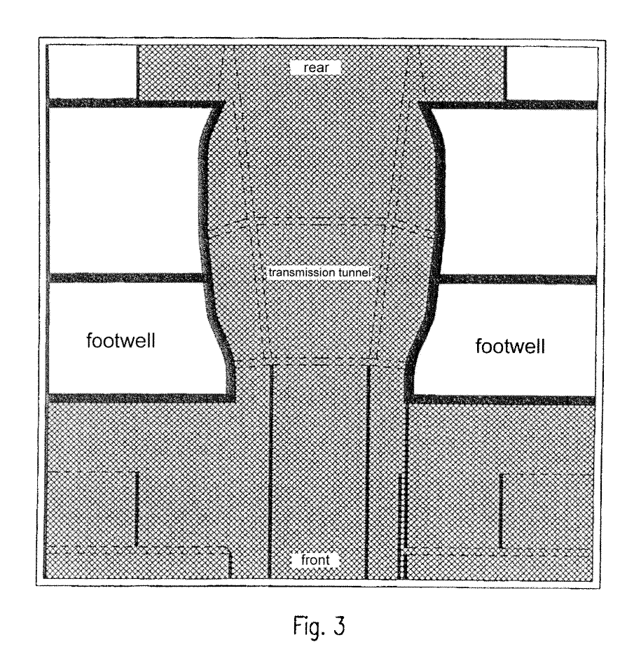

FIG. 2 in section, a mass layer according to the invention with locally variable quantity of granular material,

FIG. 3 in top view, a sound-insulation part in which the invention is applicable,

FIG. 4 in section, a detail of a sound-insulation part according to the state of the art,

FIG. 5 a representation of the variable sound-deadening in the case of low and high depth of draw during thermoforming.

FIG. 1 shows a base mass layer 1 on which on one side, a visible side, a carpet 2 has been laminated, and on the other side of which a layer 3 of granular material has been applied. The layer of granular material 3 and the base mass layer 1 constitute overall the mass 4 of a mass/spring arrangement, the spring being constituted by an elastic lightweight material, such as a two-component polyurethane foam or a mixed-fiber non-woven fabric, and being foamed on the side of the layer of the granular material 3 facing away from the base mass layer 1 after a thermoforming operation, as known as such.

In order that the granular material 3 is given, on the one hand, a firm interconnection and, on the other hand, a firm connection to the base mass layer 1, the granular material 3 is sintered after being applied, in particular by applying pressure and/or temperature—for example by heating in heating bays. The arrangement represented in FIG. 1 is thermoformable, whereby the thermoforming itself also achieves a further sintering, so that after the thermoforming a solid compact mass 4 is formed, onto which the spring layer is then applied—for example, foamed—in a further working step, as known as such.

It becomes evident that the thickness of the base mass layer 1 may be very small, in which case the thickness of the layer of the granular material 3 is then correspondingly greater. What is essential is that the mass 4 as a whole is formed.

FIG. 2 shows a comparable structure of the mass 4, here without laminated-on carpet, wherein in a certain region 5 the layer thickness of the granular material 3 is distinctly greater, here twice as great, as outside region 5. In this way, significantly differing weights per unit mass of the mass 4 can be achieved locally, before the thermoforming operation, by adapting the layer thickness of the granular material 3.

Alternatively, use may also be made of a granular material 3 of variable weight per unit mass in surface region 5.

In FIGS. 1 and 2 the granular material 3 has been represented schematically in granulated form. In practice, it is advantageous if the granular material has a grain size from 0.5 mm to 6 mm, preferably 2 mm to 4 mm. In this way the desired layer height, and hence the locally higher desired mass in region 5, can be achieved, and very precisely. In this manner, locally highly variable weights per unit mass and thicknesses of the mass 4 are achieved prior to the thermoforming.

FIGS. 3 to 5 were already discussed in the introduction. FIG. 3 shows darker regions in which, for acoustic reasons, a mass layer of higher mass per unit area has to be provided locally, and also lighter regions in which a mass layer of locally lower mass per unit area satisfies the acoustic requirements.

FIG. 4 shows, in section, a detail of a sound-insulation part which is formed as a floor lining after the thermoforming and after the foam backing with the spring F. The heavy layer S, which has been manufactured—that is to say, thermoformed—from a planar semi-finished product, a blank, of continuous thickness, has highly variable thicknesses and masses per unit area after the thermoforming, depending on the depth of draw. Starting from an initial weight of the blank of 100%, in region H of high depth of draw the heavy layer or mass layer S amounts to, for example, a weight per unit area of only 50% to 60% (and ordinarily exhibits a thickness of the foam from 5 mm to 10 mm). In regions N of low depth of draw, on the other hand, the heavy layer or mass layer S exhibits a weight per unit area of approximately 90%, and in practice the foam layer or spring layer exhibits a layer thickness from 20 mm to 40 mm.

The differing conditions in regions H and N have considerable influence on the acoustic behavior, in which connection the sound-deadening, as represented in FIG. 5, between regions H and N may differ by 15 dB, starting always from an initial material of continuous thickness for the heavy layer S (initial weight 100%).

According to the invention—as represented, for example, in FIG. 2 in particular—the mass 4 can be adapted locally prior to the thermoforming in accordance with the masses desired after the thermoforming.

The depths of draw are structurally predetermined, so that the regions 5 of different layer thickness—here, higher layer thickness—can be determined very precisely.

Moreover, a locally variable sound-deadening behavior can furthermore also be taken into account by means of a locally variable application of quantities of granular material 3, adapted to said behavior. For it has become evident that body structures arising from series production have very uniform acoustic behavior over the series, so that after an appropriate acoustic measurement of one or more body parts those locations can be precisely determined at which a different mass per unit area of the mass 4 is desirable after the thermoforming.

From this it follows, furthermore, that the thickness of the base mass layer 1 can be determined in a manner depending on the minimum masses per unit area (whereby merely the capacity of still being able to be thermoformed is to be taken into account).

It becomes evident, moreover, that the base mass layer 1 can even be dispensed with if the latter is replaced by a thin and lightweight backing layer that is capable of being connected to the spring layer to be applied after the thermoforming, which is capable of being foam-backed in the case of a two-component polyurethane foam and which can optionally be provided with a carpet. In this embodiment the desired mass can be applied locally, even when a mass 4 is dispensed with locally, if, for acoustic reasons, such a mass is not required at a particular place.

The granular material 3 can be applied on the base mass layer 1, or on the backing layer, in any manner that is conventional as such; particularly suitable are procedures that permit a very precise determination of region 5 and of the height of the granular material 3 to be applied there, for instance procedures by means of which the granular material 3 is capable of being applied by means of a die, a guide bar, an engaged template or such like.

Of particular advantage is a granular material comprising the same thermoplastic material as that of the base mass layer 1, or a granular material comprising a thermoplastic material that is similar in terms of melting-point and density, since in this case the process is simplified and facilitated by virtue of the sintering and also the firm connection to the base mass layer 1.

1. Process for producing a sound-insulation part having a mass/spring structure, comprising forming a spring layer comprising an elastic lightweight material, and a mass layer, with or without laminated-on carpet and for the purpose of adaptation to the contour of a surface to be dampened subjecting the mass layer to a corresponding thermoforming process and subsequently applying the spring layer, and
depending on the depth of draw in the course of thermoforming, additionally applying a thermoplastic granular material in appropriately locally limited manner and prior to the thermoforming, to such an extent onto a base mass layer that the mass desired locally after the thermoforming is obtained in the mass layer, and prior to the thermoforming heating the applied granular material for the purpose of connection to the base mass layer.

2. Process according to claim 1,
comprising applying
a granular material comprising the same thermoplastic material as that of the base mass layer, or of a thermoplastic material that is similar to the base mass layer in terms of melting-point and density.

3. Process for producing a sound-insulation part having a mass/spring structure, comprising forming a spring layer comprising an elastic lightweight material and a mass layer, with or without laminated-on carpet, and for the purpose of adaptation to the contour of a surface to be dampened subjecting the mass layer is subjected to a corresponding thermoforming process and subsequently applying the spring layer, and
depending on the depth of draw in the course of thermoforming, applying a thermoplastic granular material, prior to the thermoforming, to such an extent in appropriately local manner onto a thin and lightweight backing layer for the purpose of forming the mass layer that the mass desired locally after the thermoforming is obtained in the mass layer, and prior to the thermoforming heating the applied granular material for the purpose of connection to the backing layer.

4. Process according to claim 3,
wherein the backing layer comprises a compressed or needled mixed-fiber non-woven fabric.

5. Process according to claim 1, comprising applying
the granular material with a grain size of 0.5 mm to 6 mm.

6. Process according to claim 1, comprising applying
the granular material by a die, a guide bar, or a rasterized template.

7. Process according to claim 1, comprising applying the granular material undertaken in accordance with the locally defined height of the bed of the granular material or in accordance with the locally applied quantity of the granular material per unit area.

8. Process according to claim 1, comprising sintering
the granular material under pressure and with supply of heat.

9. Process according to claim 8, comprising undertaking
sintering during thermoforming.

10. Sound-insulation part, comprising a mass/spring structure, wherein a spring layer comprising an elastic lightweight material and a mass layer, with or without laminated-on carpet have been formed wherein for the purpose of adaptation to the contour of a surface to be dampened the mass layer has been correspondingly thermoformed,
wherein
on a base mass layer additionally a thermoplastic granular material has been applied which, depending on the depth of draw in the course of thermoforming, has been applied to such an extent in appropriately locally limited manner and prior to the thermoforming, whereby prior to the thermoforming the applied granular material has been heated for the purpose of connection to the mass layer in such a manner that the mass desired locally after the thermoforming is obtained in the mass layer.

11. Sound-insulation part according to claim 10,
wherein
the granular material comprises the same thermoplastic material as that of the base mass layer, or of a thermoplastic material that is similar to the base mass layer in terms of melting-point and density.

12. Sound-insulation part comprising a mass/spring structure,
wherein a spring layer comprising an elastic lightweight material, and a mass layer, with or without laminated-on carpet, are formed, whereby for the purpose of adaptation to the contour of a surface to be dampened the mass layer has been correspondingly thermoformed,
wherein
on a thin and lightweight backing layer a thermoplastic granular material has been applied for the purpose of forming the mass layer, which, depending on the depth of draw in the course of thermoforming has been applied to such an extent in appropriately local manner prior to the thermoforming, wherein prior to the thermoforming the applied granular material has firstly been heated for the purpose of connection to the backing layer in such a manner that the mass desired locally after the thermoforming is obtained in the mass layer.

13. Sound-insulation part according to claim 12,
wherein
the backing layer is a compressed or needled mixed-fiber non-woven fabric.

14. Sound-insulation part according to claim 10, wherein
the granular material has a grain size of 0.5 mm to 6 mm.

15. Sound-insulation part according to claim 10, wherein
the granular material has been applied by means of a die, a guide bar, or a rasterized template.

16. Sound-insulation part according to claim 10, wherein
the application of the granular material has been undertaken in accordance with the locally defined height of the bed of the granular material or in accordance with the locally applied quantity of the granular material per unit area.

17. Sound-insulation part according to claim 10, wherein
the granular material has been sintered under pressure and with supply of heat.

18. Sound-insulation part according to claim 17,
wherein sintering was counted out during the thermoforming.

19. Sound-insulation part according to claim 10,
for the covering of the floor region of a motor vehicle in the region of the transmission tunnel, and/or for the covering of the region pointing towards the engine and/or of the flat regions in the footwell.

20. Process according to claim 1, wherein the elastic lightweight material comprises a two-component polyurethane foam or a mixed-fiber non-woven fabric.

21. Process according to claim 3, wherein the elastic lightweight material comprises a two-component polyurethane foam or a mixed-fiber non-woven fabric.

22. Process according to claim 1, comprising applying the granular material with a grain size of 2 mm to 4 mm.

23. Sound-insulation part according to claim 10, wherein the elastic lightweight material comprises a two-component polyurethane foam or a mixed-fiber non-woven fabric.

24. Sound-insulation part according to claim 12, wherein the elastic lightweight material comprises a two-component polyurethane foam or a mixed-fiber non-woven fabric.

25. Sound-insulation part according to claim 10, comprising applying the granular material with a grain size of 2 mm to 4 mm.
